(19) United States
(12) Patent Application Publication
(10) Pub. No.: US 2011/0062216 A1
(43) Pub. Date: Mar. 17, 2011

(54) Method for manufacturing semiconductor device and bonding apparatus

(75) Inventor: Tsutomu SANO, Kanagawa (JP)

(73) Assignee: RENESAS ELECTRONICS CORPORATION, Kawasaki-shi (JP)

(21) Appl. No.: 12/923,311

(22) Filed: Sep. 14, 2010

(30) Foreign Application Priority Data
Sep. 17, 2009 (JP) 2009-215400

(51) Int. Cl. B23K 20/10; B23K 20/00

(52) U.S. Cl. 228/102; 228/1.1

(57) ABSTRACT

A bonding apparatus includes: a storage unit that stores bonding conditions of a ball; a detection unit that detects a first position on a Z axis of a capillary with the ball coming into contact with a semiconductor element and detects a second position on the Z axis of the capillary when the ball at the tip end of the capillary is bonded to the semiconductor element; a calculation unit that calculates a collapse amount of the ball which is a difference between the first position and the second position detected by the detection unit and a bonding time and calculates a collapse amount of the ball for a predetermined period; and a first adjustment unit that adjusts the bonding conditions when the collapse amount of the ball for a predetermined period is outside a predetermined numerical range.

The application is based on Japanese patent application No. 2009-215400, the content of which is incorporated hereinto by reference.

### BACKGROUND

1. Technical Field

The present invention relates to a method for manufacturing a semiconductor device and a bonding apparatus.

2. Related Art

In processes of manufacturing semiconductor devices, wire bonding is performed so as to connect a pad of a semiconductor element and a lead over a substrate.

In order to bond a metal wire to the pad of the semiconductor element, first, the tip end of the metal wire inserted through a capillary of a bonding apparatus is melted by electric discharge or the like to form a ball (see Japanese Published patent application A-H07-022456). The ball is bonded to the pad of the semiconductor element heated to a predetermined temperature. In this case, bonding is carried out while applying load and ultrasonic wave to the ball (see Japanese Unexamined patent publication NO. 2000-223526). As materials of the metal wire, gold alloy, copper alloy, and the like are used. Then, as a similar to the process of wire bonding, there is a die bonding process (see Japanese Unexamined patent publication NOS. 2006-278888 and 2005-039096).

The bonding process generally has a problem in that the collapse profiles of the balls bonded to the pad of the semiconductor element vary greatly from ball to ball. When the amount of collapse of the balls is small, bonding defects are apt to occur between the wire and the pad of the semiconductor element. On the other hand, when the amount of collapse of the balls is large, the balls become flat and there is a possibility that adjacent balls come into contact with each other.

As a result of investigation, the present inventor found that contamination of the capillary during the repeated bonding process and insufficient transmission of the ultrasonic wave to the balls are the causes of the variation in the ball collapse profile. It was also found that a package structure is the cause of the variation in the ball collapse profile.

However, method of correcting parameter of work positioning stage device is disclosed (see Japanese Published patent application A-H06-236904), hitherto it was difficult to easily grasp the exact quantitative information on the ball collapse profile in situ (during the bonding operation). Therefore, was not possible to recognize troubles associated with changes with time in the bonding tool, and the yield of the semiconductor device was deteriorated.

### SUMMARY

In one embodiment, there is provided a method for manufacturing a semiconductor device, comprising:

detecting a first position over the Z axis of a capillary to move a capillary, through which a wire including a ball formed at a tip end is inserted, along a direction of a Z axis which is an axis in an up-down direction so that the ball comes into contact with a semiconductor devices;

detecting a second position over the Z axis of the capillary to apply a load, an oscillation output of an ultrasonic wave and ultrasonic wave vibration to the ball at a tip end of the capillary, and to perform thus bonding;

grasping a collapse amount of the ball which is a difference between the first position and the second position and a bonding time taken to complete movement from the first position to the second position;

grasping a ball collapse amount for a predetermined period or a bonding time corresponding to a predetermined ball collapse amount from the collapse amount of the ball and the bonding time;

determining whether or not the ball collapse amount for a predetermined period or the bonding time corresponding to a predetermined ball collapse amount is within a predetermined numerical range; and

adjusting at least one of the load applied to the ball and an oscillation output amount of the ultrasonic wave, which are bonding conditions, when it is determined in the step of determining that the ball collapse amount or the bonding time corresponding to a predetermined ball collapse amount is not within the predetermined numerical range.

According to the above embodiment, the ball collapse amount for a predetermined period or the bonding time corresponding to a predetermined ball collapse amount is grasped, and if the ball collapse amount for a predetermined period or the bonding time corresponding to a predetermined ball collapse amount is outside the predetermined numerical range, the bonding conditions are adjusted so that the ball collapse amount for a predetermined period or the bonding time corresponding to a predetermined ball collapse amount falls within the predetermined numerical range.

By adjusting the bonding conditions so that the ball collapse amount for a predetermined period or the bonding time corresponding to a predetermined ball collapse amount falls within the predetermined numerical range, it is possible to control the collapse speed of the ball so as to be within a predetermined range.

By controlling the collapse speed of the ball so as to be within the predetermined range, it is possible to maintain a uniform ball collapse profile.

In addition, in order to maintain a uniform ball collapse profile, a method of adjusting only the bonding time may be considered. For example, a method may be considered in which the bonding time is extended until the ball collapse amount reaches a predetermined amount if the collapse speed of the ball is decreased from that in the initial state where the bonding starts.

However, if the bonding time is extended too much, it may have a great influence on the yield of the semiconductor device.

In contrast, according to the above embodiment of the present invention, as described above, since the collapse speed of the ball can be controlled so as to be within a predetermined range, it is possible to maintain a constant ball collapse profile without greatly extending the bonding time.

The present invention may be embodied as a bonding apparatus for manufacturing a semiconductor device in addition to the method for manufacturing a semiconductor device.

In another embodiment, there is provided a bonding apparatus, performing bonding, which includes a capillary, through which a wire including a bonding ball formed at a tip end is inserted, and in which after the ball at a tip end of the capillary is brought into contact with a semiconductor device, a load is applied to the ball, and an ultrasonic wave is oscillated and output to apply an ultrasonic wave vibration to the ball,

the capillary moves along a direction of a Z axis which is an axis in an up-down direction so that the ball comes into contact with the semiconductor device, and the bonding apparatus comprising:

a storage unit that stores the load applied to the ball and an oscillation output amount of the ultrasonic wave which are bonding conditions of the ball;

a detection unit that detects a first position over the Z axis of the capillary by moving the capillary along the Z-axis direction so as to make contact with the semiconductor device, and detects a second position over the Z axis of the capillary when the ball at the tip end of the capillary is bonded by applying a load and an ultrasonic wave vibration to the ball based on the bonding conditions stored in the storage unit;

a calculation unit that grasps a collapse amount of the ball which is a difference between the first position and the second position detected by the detection unit and a bonding time taken to complete movement from the first position to the second position and calculates a collapse amount of the ball for a predetermined period or a bonding time corresponding to a predetermined ball collapse amount from the collapse amount of the ball and the bonding time; and

a first adjustment unit that adjusts at least one of the load applied to the ball and the oscillation output amount of the ultrasonic wave which are the bonding conditions stored in the storage unit when the collapse amount of the ball for the predetermined period or the bonding time corresponding to the predetermined ball collapse amount calculated by the calculation unit is not within a predetermined numerical range.

According to the embodiments of the present invention, a method for manufacturing a semiconductor device and a bonding apparatus capable of maintaining a constant ball collapse profile without greatly affecting the yield of the semiconductor device are provided.

### BRIEF DESCRIPTION OF THE DRAWINGS

The above and other objects, advantages and features of the present invention will be more apparent from the following description of certain preferred embodiments taken in conjunction with the accompanying drawings, in which:

FIG. 1 shows a block diagram of a bonding apparatus according to a first embodiment of the present invention;

FIG. 2 shows a method of forming a ball at a tip end of a capillary;

FIG. 3 shows the relationship between a bonding time and a ball collapse amount;

FIG. 4 shows a block diagram of a bonding apparatus according to a second embodiment of the present invention;

FIG. 5 shows the relationship between a bonding time and a ball collapse amount;

FIG. 6 shows a block diagram of a bonding apparatus according to a third embodiment of the present invention; and

FIG. 7 shows the relationship between the applied power of an ultrasonic wave and the bonding count.

### DETAILED DESCRIPTION

The invention will be now described herein with reference to illustrative embodiments. Those skilled in the art will recognize that many alternative embodiments can be accomplished using the teachings of the present invention and that the invention is not limited to the embodiments illustrated for explanatory purposes.

Hereinafter, embodiments of the present invention will be described based on the drawings.

### First Embodiment

First, an overview of a bonding apparatus of the present embodiment will be described.

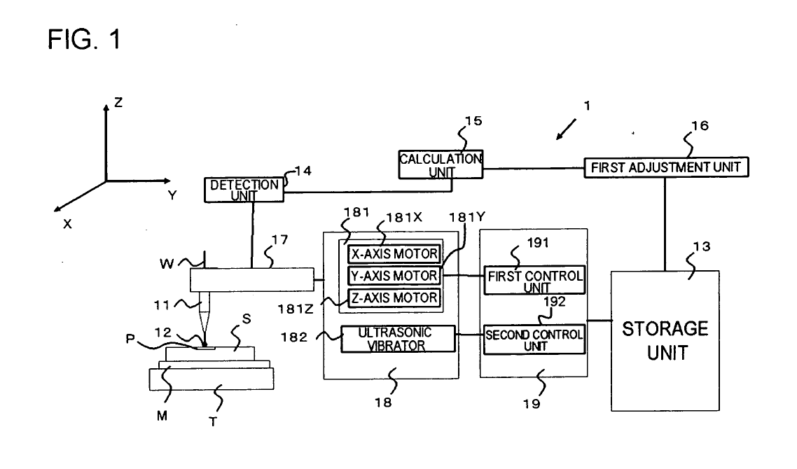

As shown in FIG. 1, a bonding apparatus 1 of the present embodiment includes a capillary 11 through which a wire W having a bonding ball 12 formed at a tip end is inserted. The ball 12 is brought into contact with a pad P of a semiconductor element (semiconductor device) S heated to a predetermined temperature by a heater (not shown) that is laid on a table T. Thereafter, the ball 12 is bonded to the pad P by applying a load and an ultrasonic wave to the ball 12. Subsequently, the other end of the wire W is bonded to a lead (not shown) of a substrate M similarly by applying a load and an ultrasonic wave to the other end of the wire W. In this way, the pad P of the semiconductor element S is electrically connected to the lead of the substrate M. The present invention is useful for such a wire bonding process, and particularly, for achieving stable bonding of the pad P of the semiconductor element S and the ball 12. Hereinafter, the bonding of only the semiconductor element S side will be described, and the present invention is also useful for performing bonding of the substrate M side.

The capillary 11 moves along the direction of a Z axis which is an axis in the up-down direction (perpendicular direction) so as to bring the ball 12 into contact with the pad P of the semiconductor element S.

The bonding apparatus 1 includes a storage unit 13, a detection unit 14, a calculation unit 15, and a first adjustment unit 16. The storage unit 13 stores bonding conditions of the ball 12. The detection unit 14 moves the capillary 11 along the Z-axis direction to bring the ball 12 formed at the tip end of the wire W inserted through the capillary 11 into contact with the pad P of the semiconductor element S and detects a first position on the Z axis of the capillary 11. The detection unit 14 detects a second position on the Z axis of the capillary 11 when the capillary 11 is bonded to the ball 12 by applying a load and an ultrasonic wave to the ball 12 based on the bonding conditions stored in the storage unit 13. The calculation unit 15 calculates a collapse amount of the ball 12 which is a difference between the first position and the second position detected by the detection unit 14 and a bonding time taken to complete the movement from the first position to the second position. The calculation unit 15 calculates a collapse amount of the ball 12 for a predetermined period or a bonding time corresponding to a predetermined collapse amount of the ball 12 from the calculated collapse amount of the ball 12 and the calculated bonding time. If the collapse amount of the ball 12 for a predetermined period, or the bonding time corresponding to a predetermined collapse amount of the ball 12, calculated by the calculation unit 15 is outside a predetermined numerical range, the first adjustment unit 16 adjusts the bonding conditions so that the collapse amount of the ball 12 for a predetermined period, or the bonding time corresponding to a predetermined collapse amount of the ball 12 falls within the predetermined numerical range. If the collapse amount of the ball 12 for a predetermined period, or the bonding time corresponding to a predetermined collapse amount of the ball 12 is within the predetermined numerical range, the first adjustment unit 16 does not adjust the bonding conditions.

Next, the bonding apparatus 1 will be described in detail.

The bonding apparatus 1 includes a supporting member 17 that supports the capillary 11, a driving unit 18, a drive control unit 19, and a timer unit 20, in addition to the above-described capillary 11, storage unit 13, detection unit 14, calculation unit 15, and first adjustment unit 16.

The capillary 11 is configured such that the wire W is inserted therethrough, and the tip end of the wire W protrudes from the tip end. The capillary 11 is supported by the supporting member 17. The supporting member 17 is driven along the X, Y, and Z-axis directions whereby the capillary 11 is also driven. In this specification, the Z-axis direction is the axis in the perpendicular direction (axis vertical to the semiconductor element S), and the X and Y-axis directions are the axes in the horizontal direction.

The driving unit 18 drives the supporting member 17. The driving unit 18 includes motors 181 (181X, 181Y, and 181Z) for driving the supporting member 17 in the X, Y, and Z-axis directions and an ultrasonic vibrator 182.

The ultrasonic vibrator 182 is a piezoelectric device, for example. When a voltage is applied to the ultrasonic vibrator 182, the ultrasonic vibrator 182 oscillates and outputs an ultrasonic wave vibration. The ultrasonic wave vibration is transmitted to the capillary 11 through the supporting member 17.

The drive control unit 19 controls the driving of the driving unit 18. Specifically, the drive control unit 19 includes a first control unit 191 for controlling the driving of the motors 181 and a second control unit 192 for controlling the driving of the ultrasonic vibrator 182.

The drive control unit 19 controls the driving unit 18 based on the bonding conditions stored in the storage unit 13. Specifically, the drive control unit 19 moves the capillary 11 to a predetermined position (for example, the central position of the pad P of the semiconductor element S and a predetermined position of the lead (not shown) of the substrate M) based on the X and Y coordinates stored in the storage unit 13. Similarly, the drive control unit 19 drives the motor 181Z based on the load conditions stored in the storage unit 13 to control the load applied to the ball 12 at the time of performing bonding.

Moreover, the drive control unit 19 controls the ultrasonic vibrator 182 based on the ultrasonic output power stored in the storage unit 13.

Furthermore, the drive control unit 19 controls the driving of the ultrasonic vibrator 182 and the motor 181Z based on the bonding time which is taken to complete the movement from the first position to the second position and is stored in the storage unit 13.

The detection unit 14 detects the position on the Z axis of the capillary 11. Specifically, the detection unit 14 detects the position on the Z axis of the capillary 11 using an encoder attached to the motor 181Z. The detection unit 14 is configured to always detect the position of the capillary 11 at the time of performing bonding. However, the driving unit 14 may be configured to detect at least the first position on the Z axis of the capillary 11 when the ball 12 comes into contact with the pad P of the semiconductor element S and the second position on the Z axis of the capillary 11 when the ball 12 at the tip end of the wire W inserted through the capillary 11 is bonded to the pad P by applying a load and an ultrasonic wave thereto.

It should be noted that the positions in the X and Y-axis directions of the capillary 11 may be detected by the detection unit 14.

The calculation unit 15 calculates the collapse amount of the ball 12 for a predetermined period. The calculation unit 15 grasps the collapse amount of the ball 12 which is a difference between the first position and the second position detected by the detection unit 14 and the bonding time taken to complete the movement from the first position to the second position. Moreover, the calculation unit 15 calculates the collapse amount of the ball 12 for a predetermined period from the calculated collapse amount of the ball 12 and the calculated bonding time. It should be noted that as the ball collapse amount for a predetermined period, a collapse speed (μm/s) of the ball 12 may be calculated, and alternatively, a collapse amount of the ball 12 for a given fixed period (for example, 10 ms) may be calculated.

The first adjustment unit 16 adjusts the bonding conditions stored in the storage unit 13.

The first adjustment unit 16 determines whether or not the collapse amount of the ball 12 for a predetermined period calculated by the calculation unit 15 is within a predetermined numerical range. If the collapse amount of the ball 12 for a predetermined period calculated by the calculation unit 15 is determined to be outside the predetermined numerical range, the first adjustment unit 16 adjusts the bonding conditions stored in the storage unit 13. That is, the collapse amount of the ball 12 for a predetermined period is adjusted so as to fall within the predetermined numerical range.

On the other hand, if the collapse amount of the ball 12 for a predetermined period calculated by the calculation unit 15 is determined to be within the predetermined numerical range, the first adjustment unit 16 does not adjust the bonding conditions stored in the storage unit 13.

Next, a method for manufacturing a semiconductor device using the bonding apparatus 1 will be described.

First, an overview of the method for manufacturing a semiconductor device will be described.

A method of manufacturing a semiconductor device according to the present embodiment includes: a step of moving the capillary 11, through which the wire W having the ball 12 formed at the tip end is inserted, along the direction of the Z axis which is the axis in the up-down direction so that the ball 12 comes into contact with the pad P of the semiconductor element S and detecting the first position on the Z axis of the capillary 11;

a step of applying a load and an ultrasonic wave to the ball 12 at the tip end of the capillary 11 so as to achieve bonding;

a step of detecting the second position on the Z axis of the capillary 11 when bonding is achieved;

a step of grasping the collapse amount of the ball 12 which is the difference between the first position and the second position and the bonding time taken to complete the movement from the first position to the second position; and

a step of grasping the collapse amount of the ball 12 for a predetermined period from the calculated collapse amount of the ball 12 and the calculated bonding time.

If the collapse amount of the ball 12 for a predetermined period is outside the predetermined numerical range, the bonding conditions are adjusted so that the collapse amount of the ball 12 for a predetermined period falls within the predetermined numerical range. If the collapse amount of the ball 12 for a predetermined period is within the numerical range, the bonding conditions are not adjusted.

Next, the method for manufacturing a semiconductor device according to the present embodiment will be described in detail.

First, the substrate M having the semiconductor element S attached thereto is placed on the table T (step S1).

Subsequently, the positions in the X and Y-axis directions of the capillary 11 relative to the semiconductor element S are fixed (step S2).

After that, the capillary 11 is lowered towards the semiconductor element S side so that the ball 12 comes into contact with the pad P of the semiconductor element S (step S3).

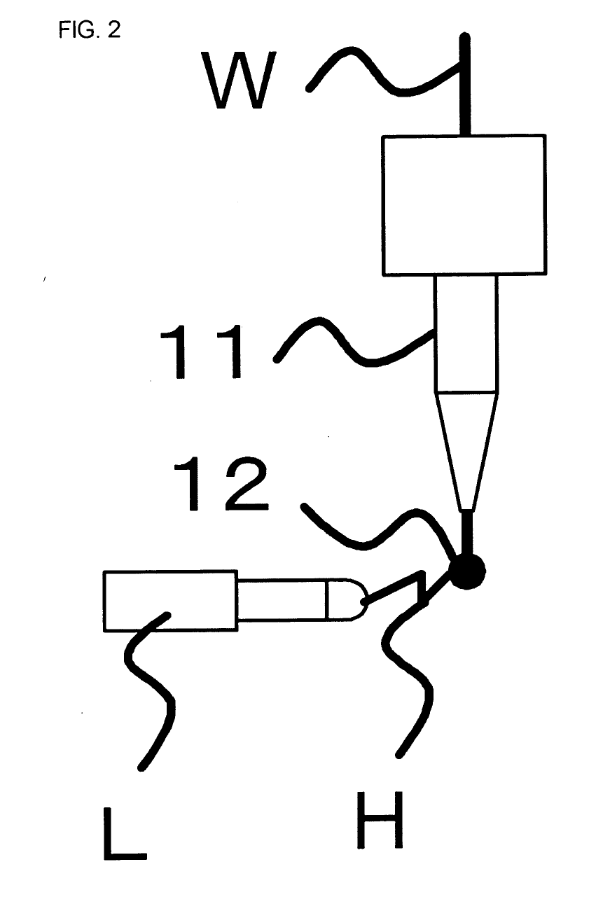

The ball 12 is formed in such a way that after the other end of the wire W is bonded to the lead (not shown) of the substrate M, the wire W is ripped off, and a spark lot L is moved close to the tip end of the wire W protruding from the capillary 11 as shown in FIG. 2 to apply a high voltage to the tip end to cause a spark discharge (depicted by symbol H in FIG. 2).

Subsequently, bonding is performed based on the bonding conditions stored in the storage unit 13 (step S4). The first control unit 191 of the drive control unit 19 drives and controls the motor 181Z that controls the position on the Z axis of the capillary 11 based on the load stored in the storage unit 13 so as to apply a load to the ball 12. The second control unit 192 drives the ultrasonic vibrator 182 based on the vibration conditions of the ultrasonic vibrator stored in the storage unit 13 so as to apply an ultrasonic wave vibration to the ball 12.

In this way, the ball 12 is bonded to the pad P of the semiconductor element S.

The position on the Z axis of the capillary 11 is detected by the detection unit 14 when the bonding apparatus 1 is operating.

The calculation unit 15 calculates the ball collapse amount from the position of the capillary 11 detected by the detection unit 14 (step S5). Specifically, the calculation unit 15 calculates the ball collapse amount from the Z-axis position (first position) of the capillary 11 when the capillary 11 is lowered towards the semiconductor element S side so that the ball 12 comes into contact with the pad P of the semiconductor element S (the bonding start time) and the Z-axis position (second position) of the capillary 11 when the ball 12 is bonded by applying a load and an ultrasonic wave vibration thereto (the bonding end time). Here, the bonding end time means the time at which the time elapsed from the bonding start time reaches the load and ultrasonic wave application time stored in the storage unit 13.

The calculation unit 15 calculates the ball collapse amount for a predetermined period, in this embodiment, for a period from the start to end of the bonding, based on the bonding time stored in the storage unit 13 and the difference between the first position and the second position (step S6).

Subsequently, the first adjustment unit 16 acquires the results of the calculation by the calculation unit 15 and determines whether or not the collapse amount of the ball 12 for a predetermined period calculated by the calculation unit 15 is within the predetermined numerical range (step S7).

If the collapse amount of the ball 12 for a predetermined period calculated by the calculation unit 15 is determined to be outside the predetermined numerical range, the first adjustment unit 16 adjusts the bonding conditions stored in the storage unit 13 (step S8). That is, the collapse amount of the ball 12 for a predetermined period is adjusted so as to fall within the predetermined numerical range.

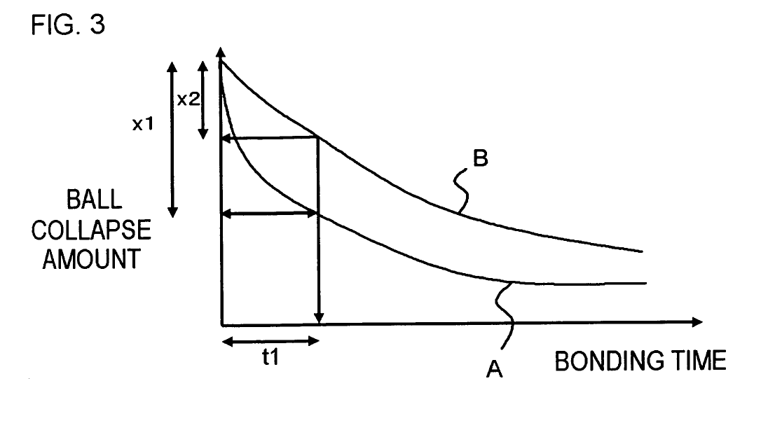

For example, as shown in FIG. 3, when bonding is started by the bonding apparatus 1, as shown by curve A, the collapse speed of the ball 12 is high, and the ball collapse amount for a predetermined period t1 is x1. However, when the bonding is repeated, the collapse speed of the ball 12 may decrease, and as shown by curve B, the collapse amount of the ball 12 for a predetermined period t1 may become x2 which is outside the predetermined numerical range.

In this case, the first adjustment unit 16 may increase the ultrasonic power (the output amount of ultrasonic wave) among the bonding conditions stored in the storage unit 13 so that the collapse amount of the ball 12 for a predetermined period falls within the predetermined numerical range. Regarding the amount of increase in the ultrasonic power, the first adjustment unit 16 may grasp the amount of deviation of the ball collapse amount for a predetermined period from the predetermined numerical range and set the amount of increase in the ultrasonic power in accordance with the amount of deviation. Specifically, the amount of deviation (not shown) of the ball collapse amount for a predetermined period from the predetermined numerical range and the amount of increase in the ultrasonic power may be stored in the storage unit 13, and the first adjustment unit 16 may increase the ultrasonic power based on the data stored in the storage unit 13.

A load may be increased without being limited to the ultrasonic power. In this case, the first adjustment unit 16 may grasp the amount of deviation of the collapse amount of the ball 12 for a predetermined period from the predetermined numerical range and increase the load in accordance with the amount of deviation.

Both the ultrasonic power and the load may be adjusted.

If the collapse speed of the ball 12 is too high, the first adjustment unit 16 may grasp the amount of deviation of the ball collapse amount for a predetermined period from the predetermined numerical range and adjust the bonding conditions (at least one of the ultrasonic power and the load) in accordance with the amount of deviation.

By doing so, it is possible to form balls having a desired shape without greatly changing the bonding time when performing wire bonding later.

On the other hand, if the collapse amount of the ball 12 for a predetermined period calculated by the calculation unit 15 is determined to be within the predetermined numerical range, the bonding conditions stored in the storage unit 13 are not adjusted (step S9).

By the above-described steps, the bonding of the pad P of the semiconductor element S and the wire W (the ball 12) is completed. Subsequently, the lead (not shown) on the substrate M on which the semiconductor element S is formed is bonded to the wire held by the capillary 11 (step S10).

The step wherein the collapse amount of the ball 12 for a predetermined period is calculated, and the first adjustment unit 16 determines whether or not the bonding conditions stored in the storage unit 13 will be adjusted and adjusts the bonding conditions as necessary may be performed whenever wire bonding is executed on all of the pads and may be performed at intervals of a predetermined wire-bonding count.

Next, the operational effects of the present embodiment will be described.

In the present embodiment, the collapse amount of the ball 12 for a predetermined period is grasped, and if the collapse amount of the ball 12 for a predetermined period is outside the predetermined numerical range, the bonding conditions are adjusted so that the collapse amount of the ball 12 for a predetermined period falls within the predetermined numerical range.

By adjusting the bonding conditions so that the collapse amount of the ball 12 for a predetermined period falls within the predetermined numerical range, the collapse speed of the ball 12 can be controlled so as to be within a predetermined range.

By controlling the collapse speed of the ball 12 so as to be within the predetermined range, it is possible to maintain a uniform ball collapse profile without greatly changing the bonding time.

In addition, in order to maintain a uniform ball collapse profile, a method of adjusting the bonding time rather than adjusting the ultrasonic power, the load, or the like may be considered.

For example, a method may be considered in which the bonding time is extended if the ball collapse amount is smaller than a predetermined collapse amount, whereas the bonding time is reduced if the ball collapse amount is larger than a predetermined collapse amount.

However, this method has the following problems.

If the bonding time is extended too much, it may have a great influence on the yield of the semiconductor device.

Moreover, if the ball collapse amount is much larger than the predetermined collapse amount, that is, if the balls collapse quickly, it is difficult to shorten the bonding time, and there is a possibility that it will not be possible to control the ball collapse profile.

In contrast, in the present embodiment, the collapse amount of the ball 12 for a predetermined period is adjusted by one or both of the load and the ultrasonic power (a combination of the load and the ultrasonic power). Therefore, it is possible to prevent a decrease in the yield of the semiconductor device without greatly changing the bonding time. Moreover, even if balls collapse quickly, by adjusting the bonding conditions to adjust the collapse amount of the ball 12 for a predetermined period, it is possible to control the ball collapse profile.

### Second Embodiment

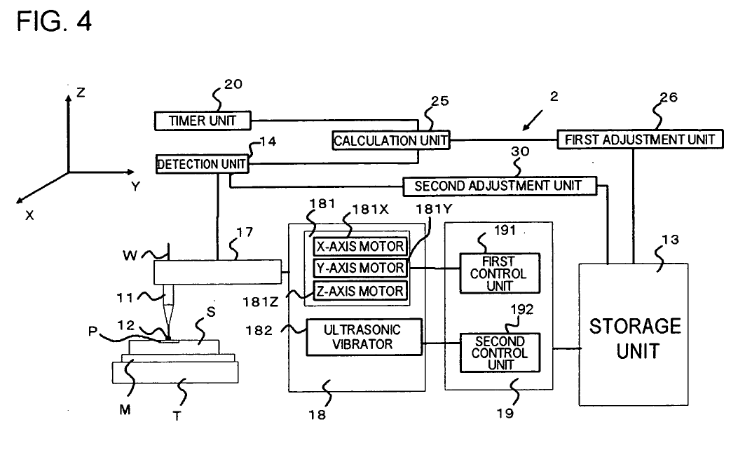

A second embodiment of the present invention will be described with reference to FIG. 4.

A bonding apparatus 2 of the present embodiment includes the capillary 11, storage unit 13, detection unit 14, supporting member 17, driving unit 18, and drive control unit 19 which are the same as those of the above embodiment. The bonding apparatus 2 further includes a calculation unit 25, a first adjustment unit 26, a second adjustment unit 30, and a timer unit 20 which are different from those of the above embodiment.

The second adjustment unit 30 adjusts the bonding time stored in the storage unit 13 so that bonding is performed (the load and the ultrasonic wave are applied to the ball 12) until the difference between the first position and the second position of the capillary 11 detected by the detection unit 14 reaches a predetermined value. The second adjustment unit 30 adjusts only the bonding time but does not adjust other bonding conditions.

The calculation unit 25 calculates a bonding time corresponding to a predetermined collapse amount of the ball 12.

The calculation unit 25 grasps the collapse amount of the ball 12 (the difference between the first position and the second position detected by the detection unit 14) and the bonding time taken to complete the movement from the first position and the second position. Moreover, the calculation unit 25 calculates a bonding time corresponding to a predetermined collapse amount of the ball 12 from the collapse amount of the ball 12 and the bonding time.

In this example, since the bonding is performed until the difference between the first position and the second position reaches a predetermined value, the bonding time corresponding to a predetermined ball collapse amount may be a bonding time corresponding to the difference between the first position and the second position.

The first adjustment unit 26 adjusts the bonding conditions stored in the storage unit 13.

The first adjustment unit 26 determines whether or not the bonding time corresponding to the predetermined ball collapse amount calculated by the calculation unit 25 is within a predetermined numerical range. If the bonding time corresponding to the predetermined ball collapse amount calculated by the calculation unit 25 is determined to be outside the predetermined numerical range, the first adjustment unit 26 adjusts the bonding conditions stored in the storage unit 13. That is, the bonding time corresponding to the predetermined ball collapse amount is adjusted so as to fall within the predetermined numerical range.

On the other hand, if the bonding time corresponding to the predetermined ball collapse amount calculated by the calculation unit 25 is determined to be within the predetermined numerical range, the bonding conditions stored in the storage unit 13 are not adjusted.

Next, a method for manufacturing a semiconductor device according to the present embodiment will be described.

First, the same steps S1 to S4 as the above embodiment are performed.

Subsequently, bonding is performed based on the bonding conditions stored in the storage unit 13 (step S5). The first control unit 191 of the drive control unit 19 drives and controls the motor 181Z that controls the position on the Z axis of the capillary 11 based on the load stored in the storage unit 13 so as to apply a load to the ball 12. The second control unit 192 drives the ultrasonic vibrator 182 based on the vibration conditions of the ultrasonic vibrator stored in the storage unit 13 so as to apply an ultrasonic wave vibration to the ball 12.

During the bonding, the second adjustment unit 30 adjusts the bonding time stored in the storage unit 13 so that the bonding is continued until the position of the capillary 11 reaches a predetermined position. That is, the second adjustment unit 30 adjusts the bonding time stored in the storage unit 13 so that the difference between the first position and the second position reaches a predetermined value.

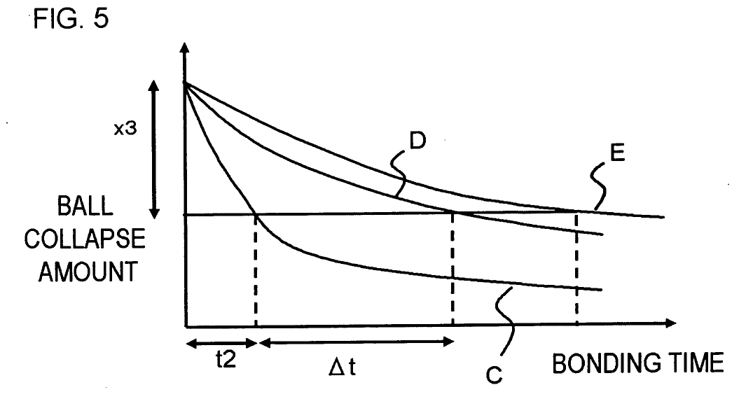

For example, it will be assumed that the storage unit 13 stores a bonding time t2 in addition to predetermined application conditions for the load and ultrasonic power, and the like. In this case, it will be assumed that the ball thickness exhibits a change as shown by curve C in FIG. 5. However, even when the bonding is performed in accordance with the bonding time t2 in addition to the predetermined conditions for the load and the ultrasonic power, and the like, only the thickness of the ball 12 is changed by a small amount as shown by curve D in FIG. 5. In this case, the second adjustment unit 30 adjusts the bonding time so as to be extended (so that the bonding time becomes t2+Δt) until the difference between the first position and the second position reaches a predetermined value x3.

In this way, the ball 12 is bonded to the semiconductor element S.

The calculation unit 25 calculates the collapse amount of the ball 12 from the position of the capillary 11 detected by the detection unit 14. Specifically, the calculation unit 25 calculates the ball collapse amount from the Z-axis position (first position) of the capillary 11 when the capillary 11 is lowered towards the semiconductor element S side so that the ball 12 comes into contact with the pad P of the semiconductor element S (the bonding start time) and the Z-axis position (second position) of the capillary 11 when the ball 12 is bonded by applying a load and an ultrasonic wave vibration thereto (the bonding end time). Here, the bonding end time means the time at which the amount of fluctuation in the Z-axis direction of the capillary 11 is equal to or smaller than a predetermined value and is in a stable state.

The timer unit 20 measures the time elapsed until the ball 12 is bonded by applying a load and an ultrasonic wave vibration thereto after the capillary 11 is lowered towards the semiconductor element S side so that the ball 12 formed at the tip end of the capillary 11 comes into contact with the pad P of the semiconductor element S. The calculation unit 25 calculates a bonding time corresponding to a predetermined collapse amount of the ball 12, in this example, the bonding time corresponding to the difference between the first position and the second position, based on the results of the measurement by the timer unit 20.

Subsequently, the first adjustment unit 26 acquires the results of the calculation by the calculation unit 25 and determines whether or not the bonding time corresponding to a predetermined ball collapse amount calculated by the calculation unit 25 is within a predetermined numerical range.

Moreover, if the bonding time corresponding to the predetermined collapse amount of the ball 12 calculated by the calculation unit 25 is determined to be outside the predetermined numerical range, the first adjustment unit 26 adjusts the bonding conditions stored in the storage unit 13. That is, the bonding time corresponding to the predetermined collapse amount of the ball 12 is adjusted so as to fall within the predetermined numerical range. For example, as shown in FIG. 5, when bonding is started by the bonding apparatus 2, as shown by curve C, the collapse speed of the ball 12 is high. However, when the bonding is repeated, the collapse speed of the ball 12 may decrease, and the bonding time corresponding to a predetermined ball collapse amount may be outside a predetermined numerical range (see curve E).

In this case, the first adjustment unit 26 may increase the ultrasonic power among the bonding conditions stored in the storage unit 13 so that the bonding time corresponding to the predetermined ball collapse amount falls within the predetermined numerical range. Regarding the amount of increase in the ultrasonic power, the first adjustment unit 26 may grasp the amount of deviation of the bonding time corresponding to the predetermined ball collapse amount from the predetermined numerical range and set the amount of increase in the ultrasonic power in accordance with the amount of deviation. Specifically, the amount of deviation (not shown) of the bonding time corresponding to the predetermined ball collapse amount from the predetermined numerical range and the amount of increase in the ultrasonic power may be stored in the storage unit 13, and the first adjustment unit 26 may increase the ultrasonic power based on the data stored in the storage unit 13.

A load may be increased without being limited to the ultrasonic power. In this case, the first adjustment unit 26 may grasp the amount of deviation of the bonding time corresponding to a predetermined collapse amount of the ball 12 from the predetermined numerical range and increase the load in accordance with the amount of deviation.

Both the ultrasonic power and the load may be adjusted.

If the collapse speed of the ball 12 is too high, the first adjustment unit 26 may grasp the amount of deviation of the bonding time corresponding to the predetermined collapse amount of the ball 12 from the predetermined numerical range and adjust the bonding conditions in accordance with the amount of deviation.

On the other hand, if the bonding time corresponding to the predetermined collapse amount of the ball 12 calculated by the calculation unit 25 is determined to be within the predetermined numerical range, the bonding conditions stored in the storage unit 13 are not adjusted.

By the above-described steps, the bonding of the pad P of the semiconductor element S and the wire W (the ball 12) is completed. Subsequently, the lead (not shown) on the substrate M on which the semiconductor element S is formed is bonded to the wire W held by the capillary 11. It should be noted that the functions of the present invention are also effective for performing bonding of the lead (not shown) on the substrate M.

According to the present embodiment described above, it is possible to obtain the same operational effects as the first embodiment, and the following advantages can be provided.

In the present embodiment, the second adjustment unit 30 adjusts the bonding time stored in the storage unit 13 so that the bonding time is extended until the difference between the first position and the second position reaches a predetermined value x3.

In this way, it is possible to ensure a constant collapse amount in all of the balls 12.

### Third Embodiment

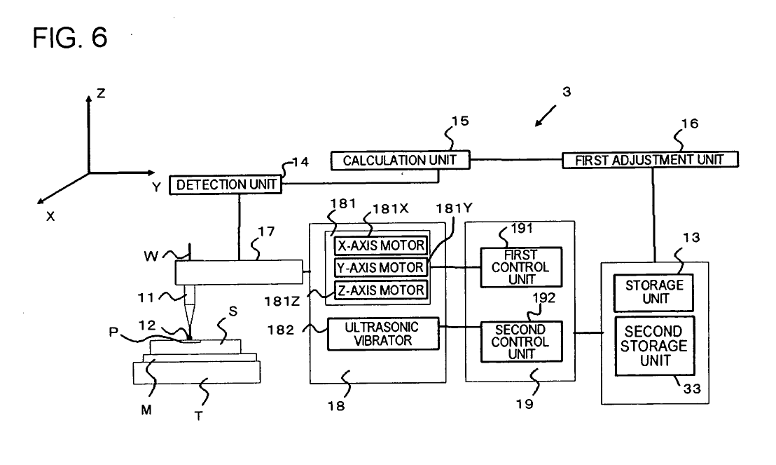

A third embodiment of the present invention will be described with reference to FIG. 6.

A bonding apparatus 3 of the present embodiment includes a second storage unit 33 in addition to the constituent elements of the bonding apparatus 1 of the first embodiment.

In the bonding apparatus 3, similarly to the first embodiment, the first adjustment unit 16 adjusts the adjusted bonding conditions (ultrasonic wave application power and load). In this case, however, the first adjustment unit 16 stores the relationship between the adjusted bonding conditions (ultrasonic wave application power and load) and the bonding count in the second storage unit 33.

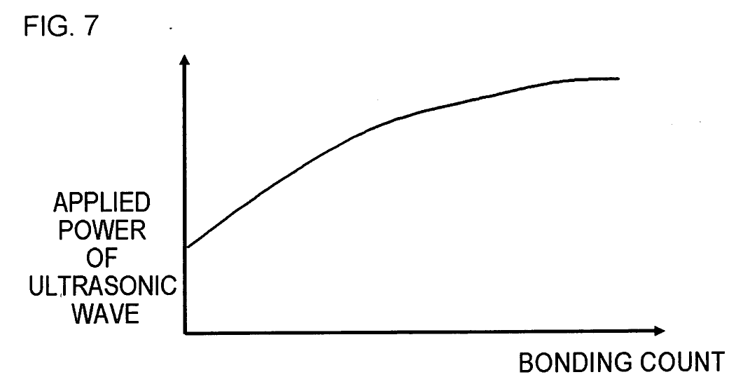

For example, when the ultrasonic wave power is adjusted by the first adjustment unit 16, the bonding count and a change in the ultrasonic power are also stored (see FIG. 7).

First, a series of operations in the steps S1 to S10 of the first embodiment are performed several times, and the relationship between the bonding count and a change in the bonding conditions is stored in the second storage unit 33.

Subsequently, bonding is performed again after replacing the capillary 11, for example. In this case, bonding of the semiconductor element S and the wire W is performed based on the relationship between the bonding count and the change in the bonding conditions stored in the second storage unit 33.

For example, when the relationship between the bonding count and the change in the ultrasonic power as shown in FIG. 7 is stored in the second storage unit 33, bonding of the semiconductor element S and the wire W is performed by adjusting the ultrasonic power in accordance with the relationship shown in FIG. 7.

According to the present embodiment described above, it is possible to obtain the same operational effects as the first embodiment, and the following advantages can be provided.

The relationship between the bonding execution count and a change in the bonding conditions is stored in the second storage unit 33, and the bonding conditions are changed based on the stored relationship, whereby a desired ball collapse profile can be obtained.

The present invention is not limited to the embodiments described above, and modifications, improvements, and the like within a range where the object of the present invention can be achieved are also included in the present invention.

In the first embodiment, although the ball collapse amount for a predetermined period was calculated, the present invention is not limited to this, and the time corresponding to a predetermined collapse amount of the ball 12 may be calculated.

It is apparent that the present invention is not limited to the above embodiments, but may be modified and changed without departing from the scope and spirit of the invention.

What is claimed is:

1. A method for manufacturing a semiconductor device, comprising:
detecting a first position over the Z axis of a capillary to move a capillary, through which a wire including a ball formed at a tip end is inserted, along a direction of a Z axis which is an axis in an up-down direction so that said ball comes into contact with a semiconductor devices;
detecting a second position over the Z axis of said capillary to apply a load, an oscillation output of an ultrasonic wave and ultrasonic wave vibration to said ball at a tip end of said capillary, and to perform thus bonding;
grasping a collapse amount of said ball which is a difference between said first position and said second position and a bonding time taken to complete movement from said first position to said second position;
grasping a ball collapse amount for a predetermined period or a bonding time corresponding to a predetermined ball collapse amount from said collapse amount of said ball and said bonding time;
determining whether or not said ball collapse amount for a predetermined period or said bonding time corresponding to a predetermined ball collapse amount is within a predetermined numerical range; and
adjusting at least one of said load applied to said ball and an oscillation output amount of said ultrasonic wave, which are bonding conditions, when it is determined in said step of determining that said ball collapse amount or said bonding time corresponding to a predetermined ball collapse amount is not within said predetermined numerical range.

2. The method for manufacturing a semiconductor device as set forth in claim 1,
wherein in said step of detecting said second position,
bonding is performed while detecting said position over the Z axis of said capillary, and
a bonding time is adjusted so that a difference between said first position and said second position reaches a predetermined value, and
after performing said step of grasping said collapse amount of said ball and said bonding time taken to complete said movement from said first position to said second position, said bonding time corresponding to a predetermined ball collapse amount is grasped in said step of grasping a ball collapse amount, and
when it is determined in said step of determining that said bonding time corresponding to a predetermined ball collapse amount is outside said predetermined numerical range, at least one of said load applied to said ball and said oscillation output amount of said ultrasonic wave is adjusted.

3. The method for manufacturing a semiconductor device as set forth in claim 1,
wherein a series of steps from said step of detecting said first position to said step of said adjusting are performed several times, so that the relationship between a bonding count and a change in said bonding conditions is grasped in advance, and
said bonding conditions are adjusted based on the relationship between said bonding count and said change in said bonding conditions, and bonding of said ball and said semiconductor device is performed.

4. A bonding apparatus, performing bonding, which includes a capillary, through which a wire including a bonding ball formed at a tip end is inserted, and in which after said ball at a tip end of said capillary is brought into contact with a semiconductor device, a load is applied to said ball, and an ultrasonic wave is oscillated and output to apply an ultrasonic wave vibration to said ball,
said capillary moves along a direction of a Z axis which is an axis in an up-down direction so that said ball comes into contact with said semiconductor device, and
said bonding apparatus comprising:
a storage unit that stores said load applied to said ball and an oscillation output amount of said ultrasonic wave which are bonding conditions of said ball;
a detection unit that detects a first position over the Z axis of said capillary by moving said capillary along said Z-axis direction so as to make contact with said semiconductor device, and detects a second position over the Z axis of said capillary when said ball at said tip end of said capillary is bonded by applying a load and an ultrasonic wave vibration to said ball based on said bonding conditions stored in said storage unit;
a calculation unit that grasps a collapse amount of said ball which is a difference between said first position and said second position detected by said detection unit and a bonding time taken to complete movement from said first position to said second position and calculates a collapse amount of said ball for a predetermined period or a bonding time corresponding to a predetermined ball collapse amount from said collapse amount of said ball and said bonding time; and
a first adjustment unit that adjusts at least one of said load applied to said ball and said oscillation output amount of said ultrasonic wave which are said bonding conditions stored in said storage unit when said collapse amount of said ball for said predetermined period or said bonding time corresponding to said predetermined ball collapse amount calculated by said calculation unit is not within a predetermined numerical range.

5. The bonding apparatus as set forth in claim 4,
wherein said bonding apparatus includes a second adjustment unit that adjusts a bonding time so that a difference between said first position and said second position reaches a predetermined value,
said calculation unit calculates a bonding time corresponding to a predetermined ball collapse amount, and
when said bonding time corresponding to said predetermined ball collapse amount is outside said predetermined numerical range, said first adjustment unit adjusts at least one of said load applied to said ball and said oscillation output amount of said ultrasonic wave stored in said storage unit so that said bonding time corresponding to said predetermined ball collapse amount falls within said predetermined numerical range.

6. The bonding apparatus as set forth in claim 4,
wherein said bonding apparatus includes a second storage unit that stores the relationship between a bonding count and a change in said bonding conditions adjusted by said first adjustment unit, and
said bonding conditions are adjusted based on the relationship between said bonding count and said change in said bonding conditions stored in said second storage unit, and bonding of said ball and said semiconductor device is performed.
